(19) United States
(12) Patent Application Publication
(10) Pub. No.: US 2007/0236322 A1
(43) Pub. Date: Oct. 11, 2007

(54) FUSE HAVING CONNECTABLE TERMINALS

(75) Inventor: Robert Skinner, Lebanon, OR (US)

Correspondence Address: IAN F. BURNS & ASSOCIATES, P.O. BOX 71115, RENO, NV, 89570, US

(73) Assignee: Jerry Edwards, Portland, OR (US)

(21) Appl. No.: 11/534,533

(22) Filed: Sep. 22, 2006

Related U.S. Application Data
(60) Provisional application No. 60/791,146, filed on Apr. 10, 2006.

(51) Int. Cl. H01H 85/30

(52) U.S. Cl. 337/244

(57) ABSTRACT

A fuse that allows for additional connections to be made. The fuse includes a housing with a body and a pair of sides. A pair of terminals may be mounted to and extend from each of the sides. At least one fusible link may be mounted inside the housing to prevent excessive current flow. A terminal is connected to each end of each of the fusible link. A light emitting diode can be mounted to the housing to indicate a positive terminal.

### CROSS REFERENCE TO RELATED APPLICATIONS

This application claims priority of U.S. provisional patent applications having Ser. No. 60/791,146 filed Apr. 10, 2006, which is hereby expressly incorporated by reference in its entirety.

### BACKGROUND

1. Field of the Invention

The present invention relates to fuses in general. More particularly, the invention relates to a fuse that has terminals that can make a secondary connection to provide power to another circuit.

2. Description of the Related Art

Fuses are commonly used to provide protection to electronic circuits from excessive current flow. Automobiles and vehicles typically use a plug or blade type fuse that plugs into a fuse block. The blade type fuse has a pair of metal blades connected by a fusible metal segment. The blades mate with contacts in the fuse block.

Vehicles commonly have additional electronics that require power. Examples of such devices are radios, stereos, GPS receivers, computers, or an auxiliary braking device used with a towed vehicle. Each of these devices requires a power source.

Since many electronic devices are never originally designed with the vehicle, the current conducted by a standard fuse may exceed the maximum current ratings of the attached electronic device.

What is needed is a fuse that can replace a conventional fuse and that can provide power and connect with an additional electronic circuit.

### SUMMARY

### Advantages of One or More Embodiments of the Present Invention

The various embodiments of the present invention may, but do not necessarily, achieve one or more of the following advantages:

provide a double sided fuse that can provide power to another circuit;

provide a fuse that can be connected to an electronic circuit breaker;

provide a fuse that can indicate the hot and ground sides of the fuse;

provide a fuse that can replace a conventional fuse in a fuse block;

provide a connector that can mate with a double sided fuse;

provide a fuse that can be connected to a circuit;

connect a secondary circuit to a circuit that was originally protected by a fuse;

protect a circuit from excessive current flow; and

allow the terminals of a fuse to be accessed.

These and other advantages may be realized by reference to the remaining portions of the specification, claims, and abstract.

### Brief Description of One Embodiment of the Present Invention

It is a feature of the present invention to provide a fuse. The fuse includes a housing. The housing has a body and a first and second end. A first terminal extends from the first end and a second terminal extends from the second end. A first fusible link is mounted within the body and is connected between the first and second terminals. A third terminal extends from the first end and a fourth terminal extends from the second end. A second fusible link is mounted within the body and is connected between the third and fourth terminals.

Another feature of the present invention is to provide a method of protecting an electrical circuit. The method includes providing a fuse block and a double ended fuse. The double ended fuse has a fuse block side and a connector side. The fuse block side is inserted into the fuse block. An electronic module is connected to the connector side.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

The embodiments of the present invention are shown in the drawings, wherein:

FIG. 1 is substantially a front perspective view of an embodiment of a fuse having connectable terminals and a fuse block in accordance with the present invention.

FIG. 2 is substantially an enlarged perspective view of a fuse having connectable terminals and a connector.

FIG. 3 is substantially a front view of a fuse having connectable terminals.

FIG. 4 is substantially a bottom view of the fuse of FIG. 3.

FIG. 5 is substantially a top view of the fuse of FIG. 3.

FIG. 6 is substantially a perspective view of a fuse having connectable terminals with the housing shown as transparent such that the inside of the fuse is shown.

FIG. 7 is substantially a front view of a connector.

FIG. 8 is substantially a top view the connector of FIG. 7.

FIG. 9 is substantially a bottom view of the connector of FIG. 7.

FIG. 10 is substantially a perspective view of a connector with the housing shown as transparent such that the inside of the connector is shown.

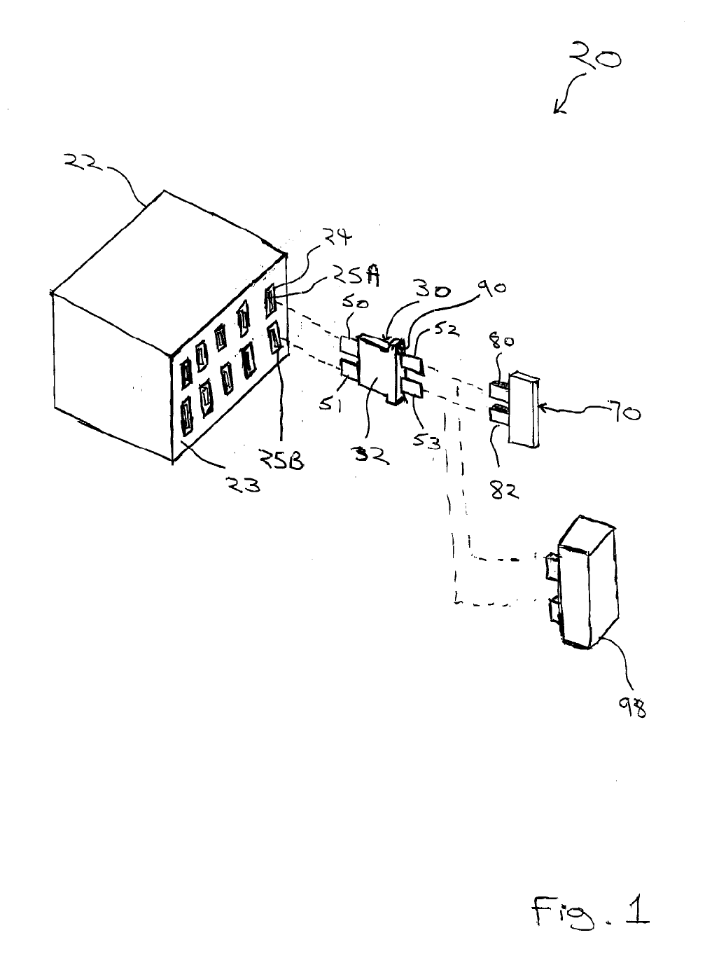

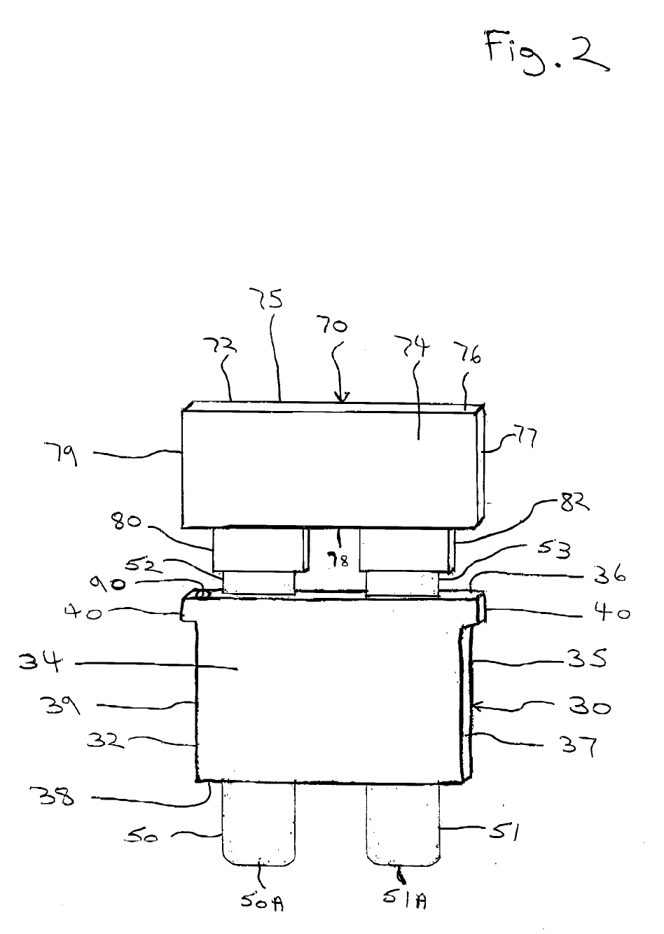

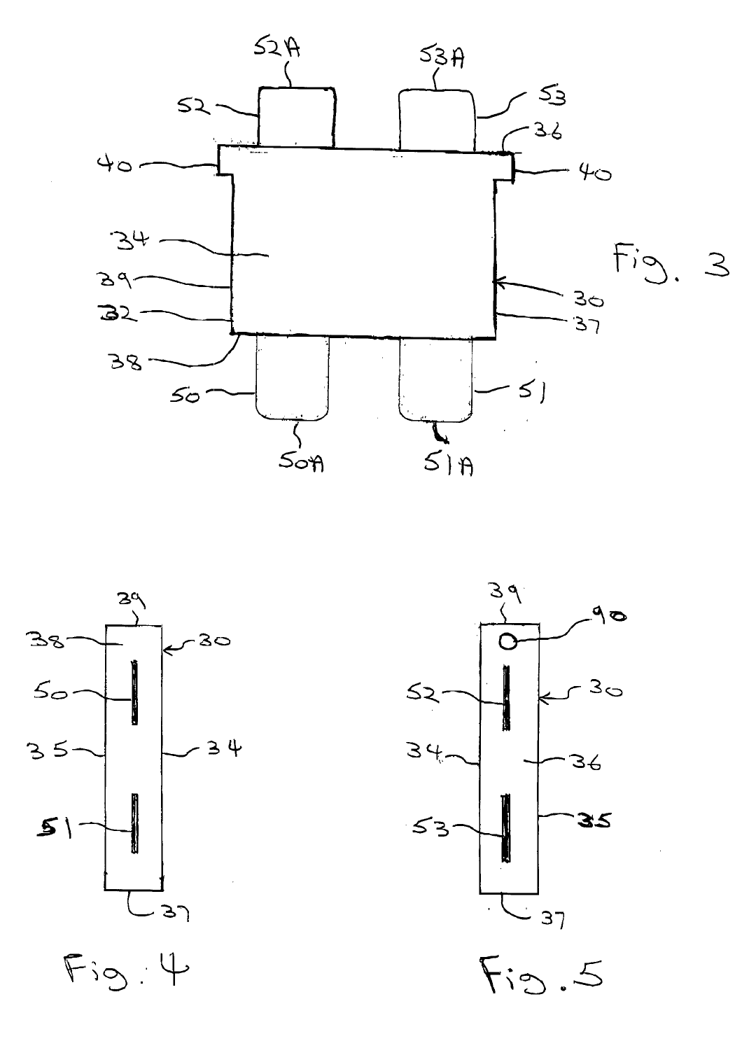

### DESCRIPTION OF THE EMBODIMENTS

In the following detailed description of the embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

The present invention comprises a fuse assembly, generally indicated by reference number 20. Referring to FIG. 1, fuse assembly 20 can include a conventional fuse block 22, a doubled ended fuse 30, a connector 70 and an electronic module 98. Fuse block 22 can include a front side 23. Apertures 24 are located on front side 23. Each aperture 24 contains a female receptacle 25. Receptacles 25A and 25B are shown. Fuse block 22 is commonly used in 12 volt electrical distribution systems in vehicles, such as cars and trucks. Fuse block 22 typically is molded from a plastic material and contains several metal receptacles 25. Receptacles 25 can mate with the blades of a conventional fuse such that a series circuit is formed between receptacles 25A and 25B. It is to be understood that this arrangement is but one embodiment that may be used with the present invention. Fuse block 22 and fuse 30 may have many other configurations, shapes, dimensions, etc.

Fuse block 22 is adapted to mate with a double ended fuse 30. Referring to FIGS. 2 thru 6, double ended fuse 30 can have a housing or body 32 that has portions or halves 32A and 32B. Housing 32 may be made of a variety of insulating materials, such as molded plastic or resins. Housing 32 can be transparent or partially transparent. Housing 32 can include an inner wall 33, an outer front side 34, an outer back side 35 and outer sides 36, 37, 38 and 39. A pair of shoulders 40 may extend outwardly from sides 37 and 39. Shoulders 40 are adapted to assist a user to grasp fuse 30 during insertion or removal of the fuse.

Fuse 30 may comprise several electrically conductive metal terminals. Terminal 50 has ends 50A and 50B. Terminal 51 has ends 51A and 51B. Terminal 52 has ends 52A and 52B. Terminal 53 has ends 53A and 53B. The terminals can be made from conventional electrically conductive terminal or electrode metal alloys such as alloys of copper or steel. Terminal ends 50B, 51B, 52B and 53B are mounted, held and contained within housing 32. Terminal ends 50A and 51A are shaped like a blade and extend away from side 38. Terminal ends 52A and 53A are shaped like a blade and extend away from side 36. Terminal end 50A is adapted to connect or mate with female receptacle 25A. Similarly, terminal end 51A can connect or mate with female receptacle 25B.

Terminal ends 52A and 53A allow for another external electrical circuit to be powered by fuse 30. Terminal ends 52A and 53A also allow for another electronic circuit or module 98 (FIG. 1) to be connected to terminal ends 52A and 53A.

Serpentine shaped fuse links 60 and 62 can be connected between the terminals. Fuse link 60 is connected between terminal ends 50B and 52B. Fuse link 62 is connected between terminal ends 51B and 53B. Fuse links 60 and 62 can be formed from conventional fuse alloys that have a melting point lower than the melting point of the terminals. Alternatively, the terminals and fuse links could all be formed from the same material. Fuse links 60 and 62 are designed to melt and cause an open circuit in the case of excessive current flow through the links.

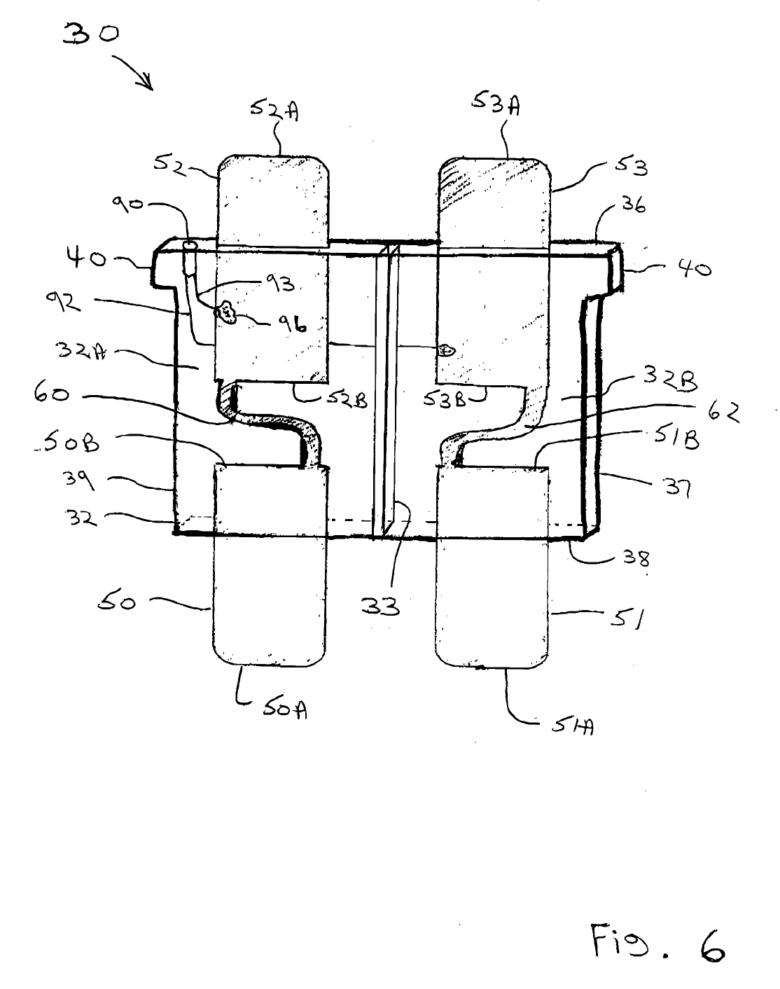

A light or light emitting diode (LED) 90 (see FIG. 6) can be mounted in housing 32 and extend through side 36 near shoulder 40. LED 90 can be any type or color of light emitting diode. LED 90 has wires 92 and 94 that extend from LED 90. Wire 92 is connected to terminal end 52B and wire 93 is connected to terminal end 53B. A solder or weld 96 can be used to connected the wires to the terminal ends. LED 90 preferably is mounted adjacent to the positive or hot terminal of the circuit. In this embodiment, terminal 52 would be the hot or positive terminal and terminal 53 the ground terminal. LED 90 would be illuminated whenever fuse 30 is plugged into a powered fuse block 22. LED 90 allows a user to visually determine which side of the fuse 30 is the hot or positive side.

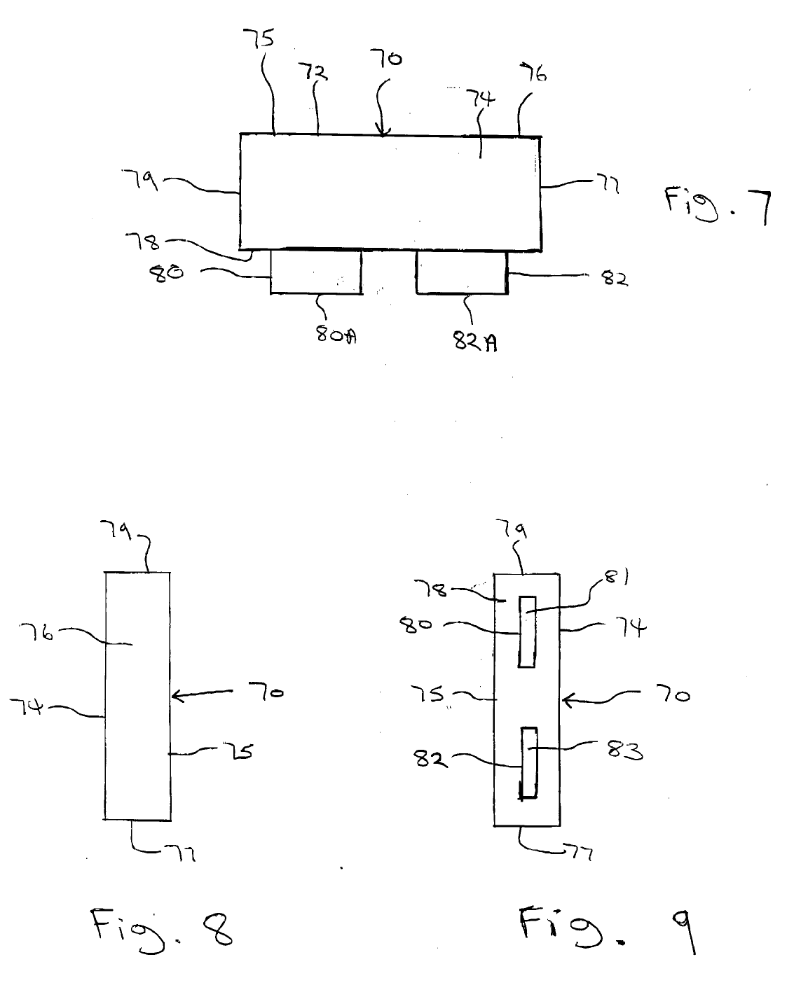

Referring to now to FIGS. 7 thru 10, a connector 70 is shown. Connector 70 can include a housing 72. Housing 72 has a front side 74, back side 75 and sides 76, 77, 78, 79. Housing 72 can be molded from plastic or resin. A pair of receptacles 80 and 82 are mounted within housing 72. Receptacle 80 may have ends 80A and 80B and a slot 81. Receptacle 82 has ends 82A and 82B and a slot 83. A metal bus bar 86 may electrically connect receptacle ends 80B and 82B together.

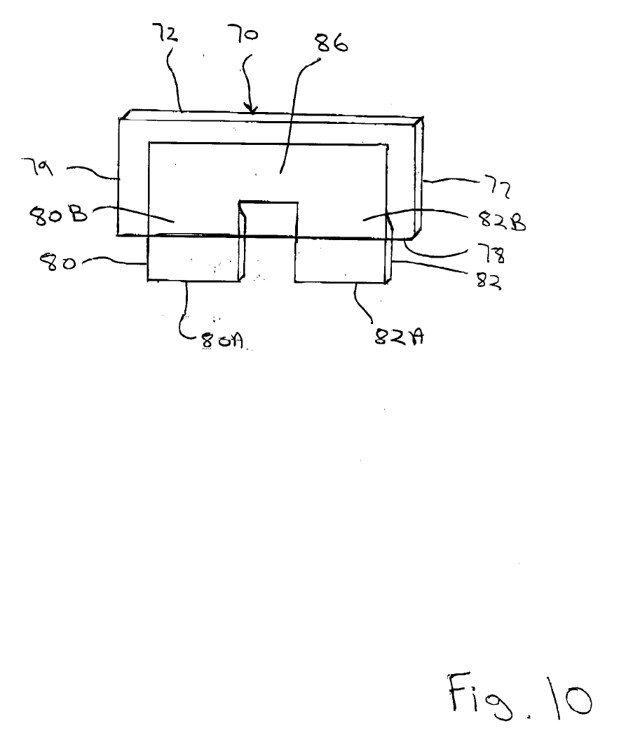

Turning to FIGS. 2 and 9, connector 70 plugs onto and mates with fuse 30. Receptacles 80 and 82 mate with terminals 52 and 53. Terminal end 52A fits into slot 81 and is held by receptacle 80. Terminal end 53A fits into slot 83 and is held by receptacle 82. Connector 70 allows terminals 52 and 53 to be shorted or connected together. With connector 70 attached, fuse 30 performs as a conventional fuse when mounted in fuse block 22.

Manufacturing

Fuse 30 can be manufactured in the following sequence of steps:

1. Terminals 50, 51, 52 and 53 are stamped out of a strip of terminal material.

2. Fusible links 60 and 62 are stamped out of a strip of fuse material.

3. Terminals 50-53 are joined to fusible links 60 and 62 by brazing or welding. Alternatively, terminals 50, 51, 52 and 53 and fusible links 60 and 62 are stamped from a single piece of material which has properties appropriate for both terminals and fusible links.

4. Wires 92 and 93 of light emitting diode 90 are soldered to terminals 52 and 53.

5. Terminals 50-53, links 60 and 62 and light emitting diode 90 are over molded with plastic to form housing 32 or placed into halves of housing 32 that are then ultrasonically welded together.

6. Fuse 30 would be electrically tested.

Connector 70 can be manufactured in the following sequence of steps:

1. Receptacles 80, 82 and bus bar 86 are stamped out of a strip of terminal material.

2. Receptacles 80, 82 and bus bar 86 are over molded with plastic to form housing 72 or placed into halves of housing 72 that are then ultrasonically welded together.

Operation

Fuse 30 replaces a conventional fuse in fuse block 22. Fuse 30 is inserted into fuse block 22 by placing blades or terminal ends 50 and 51 into receptacles 25A and 25B. Terminals 52 and 53 extend past housing 32. Terminals 52 and 53 would be connected to an external electrical circuit to be powered by fuse 30. Fuse 30 allows a secondary electrical circuit to be placed in series with the original circuit that was designed to be protected.

After fuse 30 is mounted to fuse block 22, light emitting diode 90 illuminates. Light emitting diode 90 indicates which terminal of the fuse is the hot or positive terminal.

Since, each of the terminals 52 and 53 contains a fusible link 60 and 62, when the circuit is completed by connection of an external electrical circuit; fusible links 60 and 62 perform a current limiting function. In the case of excessive current flow, one or both of fusible links 60 and 62 would melt causing an open circuit and stopping the flow of current.

Alternatively, terminals 52 and 53 can also be connected to an electronic circuit breaker. The electronic circuit breaker would be designed to disconnect the power at a lower power level than that required to melt fusible links 60 and 62. With an electronic circuit breaker, fuse 30 acts as a backup safety device to the electronic circuit breaker.

In the event that another electronic device is not connected to terminals 52 and 53, then connector 70 can be connected to terminals 52 and 53. Connector 70 shorts terminals 52 and 53 together in series such that current can flow through fusible links 60 and 62. In this manner, connector 70 allows fuse 30 to perform as a conventional fuse.

### Conclusion

It can be realized that certain embodiments of the present invention provide an additional electronic device to power and connect with the original fuse circuit in a complimentary manner to the original circuit.

The present invention allows an electronic circuit breaker or module to be easily connected in a fuse circuit before the original fuse circuit while still maintaining circuit protection. The electronic circuit breaker would have the ability to interrupt power before the fuse opens.

Certain embodiments of the present invention also provide a fuse that can visually indicate to a user the hot or positive side of the circuit.

Although the description above contains many specifications, these should not be construed as limiting the scope of the invention but as providing illustrations of some of present embodiments of this invention. Thus, the scope of the invention should be determined by the appended claims and their legal equivalents rather than by the examples given.

What is claimed is:

1. A fuse comprising:
a) a housing having a body and a first and second end;
b) a first terminal extending from the first end;
c) a second terminal extending from the second end;
d) a first fusible link mounted within the body and connected between the first and second terminals;
e) a third terminal extending from the first end;
f) a fourth terminal extending from the second end; and
g) a second fusible link mounted within the body and connected between the third and fourth terminals.

2. The fuse according to claim 1 wherein the terminals are blade shaped.

3. The fuse according to claim 1 wherein at least a portion of the housing is transparent such that the fusible links are viewable.

4. The fuse according to claim 1 wherein an insulator is located between the first and second fusible links.

5. The fuse according to claim 1 further comprising a connector fastened between the second and fourth terminals.

6. The fuse according to claim 5 wherein the connector has a housing, a first female receptacle and a second female receptacle extending from the housing

7. The fuse according to claim 6 wherein the receptacles are connected by a bar.

8. The fuse according to claim 6 wherein the first female receptacle is connected to the second terminal and the second female receptacle is connected to the fourth terminal.

9. The fuse according to claim 1 wherein a light emitting diode is mounted in the housing.

10. The fuse according to claim 9 wherein the light emitting diode indicates a hot or positive terminal.

11. A fuse comprising:
a) first terminal means for conducting electricity from a fuse block;
b) second terminal means for conducting electricity to an electrical circuit; and
c) fusible means for conducting electricity between the first and second terminal means and preventing excessive current flow in the electrical circuit.

12. The fuse according to claim 11 wherein the first and second terminal means are blade shaped.

13. The fuse according to claim 11 further comprising a housing means for supporting the first and second terminal means and the fusible means.

14. The fuse according to claim 13 wherein the housing means comprises a transparent means for viewing the fusible means.

15. The fuse according to claim 14 wherein the housing means comprises an insulator means for providing electrical insulation

16. The fuse according to claim 11 further comprising:
a) third terminal means for conducting electricity from a fuse block;
b) fourth terminal means for conducting electricity to an electrical circuit; and
c) fusible means for conducting electricity between the third and fourth terminal means and preventing excessive current flow in the electrical circuit.

18. The fuse according to claim 11 further comprising light means for indicating when the fuse is connected to an active electrical circuit.

19. The fuse according to claim 11 further comprising light means for indicating the polarity of the fuse.

20. A method of protecting an electrical circuit, but not necessarily in the order shown comprising:
a) providing a fuse block and a double ended fuse, the double ended fuse having a fuse block side and a connector side;
b) inserting the fuse block side into the fuse block; and
c) connecting an electronic module to the connector side.

21. The method of claim 20 further comprising;
a) connecting a connector to the connector side.

22. The method of claim 20 further comprising;
a) illuminating a light adjacent a hot terminal located on the connector side.
